(19) United States
(12) Patent Application Publication
(10) Pub. No.: US 2009/0073031 A1
(43) Pub. Date: Mar. 19, 2009

(54) METHOD AND SYSTEM FOR MEASURING LOCATION USING ROUND TRIP TIME INFORMATION IN MOBILE COMMUNICATION NETWORK

(75) Inventor: Shin-Jae KIM, Goyang-si (KR)

Correspondence Address: KNOBBE MARTENS OLSON & BEAR LLP, 2040 MAIN STREET, FOURTEENTH FLOOR, IRVINE, CA, 92614, US

(73) Assignee: KTFreetel Co., Ltd., Seoul (KR)

(21) Appl. No.: 12/272,575

(22) Filed: Nov. 17, 2008

Related U.S. Application Data
(63) Continuation of application No. PCT/KR2007/002391, filed on May 16, 2007.

(30) Foreign Application Priority Data
May 16, 2006 (KR) 10-2006-0043646
May 22, 2006 (KR) 10-2006-0045845

(51) Int. Cl. G01S 5/02

(52) U.S. Cl. 342/357.1; 342/450

(57) ABSTRACT

A method and position estimating system for estimating a position of a mobile terminal is disclosed. In one embodiment, the position estimating system includes i) a base station configured to compute round trip time information of a mobile terminal, ii) a base station controller configured to receive the round trip time information of the mobile terminal, iii) a repeater configured to expand a service coverage of the mobile terminal, iv) a round trip time measuring unit, being connected to the repeater and configured to measure round trip time information of the repeater and v) a position estimating device configured to estimate the position of the mobile terminal by using the round trip time information of the mobile terminal and the round trip time information measured by the round trip time measuring unit. According to one embodiment, a position of the mobile terminal can be exactly computed by using round trip time and information, stored in a network management system.

### RELATED APPLICATIONS

This application is a continuation application, and claims the benefit under 35 U.S.C. §§120 and 365 of PCT Application No. PCT/KR2007/002391, filed on May 16, 2007, which is hereby incorporated by reference.

### BACKGROUND OF THE INVENTION

1. Field of the Invention

The present invention relates to a method and system for estimating a position using round trip time information in a mobile communication network, more specifically to a method and system for exactly estimating a position of a mobile terminal by using round trip time information.

2. Description of the Related Technology

A lot of algorithms and detailed methods for tracking a position in a mobile communication network have been developed.

### SUMMARY OF CERTAIN INVENTIVE ASPECTS

One aspect of the invention is a method and system for estimating a position using a round trip time that is capable of computing an exact position of a mobile terminal in a mobile communication network.

Another aspect of the present invention is a system for estimating a position of a mobile terminal which can include a base station, computing round trip time information of a mobile terminal; a base station controller, receiving the round trip time information of the mobile terminal; a repeater, expanding a service coverage of the mobile terminal; a round trip time measuring unit, being connected to the repeater and measuring round trip time information of the repeater; and a position estimating device, estimating the position of the mobile terminal by using the round trip time information of the mobile terminal and the round trip time information measured by the round trip time measuring unit.

Another aspect of the present invention is a system for estimating a position of a mobile terminal which can include a base station, computing round trip time information of the mobile terminal; a base station controller, generating a position information message by packing the round trip time information of the mobile terminal and position related information of the mobile terminal; and a position estimating device, receiving the position information message from the base station controller and estimating a position of the mobile terminal.

Another aspect of the present invention is a method for estimating a position of a mobile terminal which can include receiving round trip time information of the mobile terminal computed by a repeater; receiving the round trip time information of the repeater from a round trip time measuring unit connected to the repeater; determining a service area of the mobile terminal by comparing the round trip time information of the repeater with the round trip time information of the mobile terminal; and estimating a position of the mobile terminal by using at least one of latitude/longitude data of the repeater and the base station, connected to the repeater, and direction information of an antenna, based on the determined service area.

Another aspect of the present invention is a method for estimating a position of a mobile terminal which can include a base station computing round trip time information of the mobile terminal; a base station controller, connected to the base station, receiving the round trip time information of the mobile terminal and position related information of the mobile terminal; at least one of the base station controller and an O&M server generating a position information message by packing the round trip time information and the position related information of the mobile terminal; and estimating a position of the mobile terminal by receiving the position information message position of the mobile terminal.

Another aspect of the invention is a system for estimating a position of a mobile terminal, the system comprising: a base station configured to compute first round trip time information of a mobile terminal; a base station controller configured to receive the first round trip time information; a repeater configured to expand a service coverage of the mobile terminal; a round trip time measuring unit being in signal communication with the repeater and configured to measure second round trip time information of the repeater; and a position estimating device configured to estimate the position of the mobile terminal based at least in part on the first and second round trip time information.

The above system further comprises a network managing system configured to store at least one of latitude and longitude data of the base station and repeater and direction information of an antenna, wherein the position estimating device is further configured to estimate the position of the mobile terminal based at least in part on the data stored in the network managing system.

In the above system, the repeater is an optical repeater or an RF repeater, and the round trip time measuring unit is further configured to compute the second round trip time information based at least in part on at least one of i) self delay of the base station, ii) self delay of the mobile terminal, iii) wireless link delay between the base station and the repeater, and iv) self delay of the repeater. In the above system, the position estimating device is further configured to determine a service area of the mobile terminal based at least in part on comparison of the first round trip time information, corresponding to at least one base station, and the second round trip time information corresponding to at least one repeater belonging to each base station.

In the above system, the position estimating device is at least one of a standalone A-GPS serving mobile location center (SMLC), being connected to the base station controller, an SMLC, being included in the base station controller, and an apparatus for estimating a position, located outside a network. The above system further comprises an operating and management (O&M) server, configured to maintain B and repair the base station, wherein, if the position estimating device is an apparatus for estimating a position, located outside the network, at least one of the base station controller and the O&M server is configured to generate a position information message by packing position related information and the first round trip time information.

In the above system, the position related information comprises at least one of i) an identifier of a mobile switching center for a circuit call included in a mobile communication network, ii) an identifier of a base station controller, iii) an identifier of a base station, iv) an identifier of a sector, v) pseudo noise information, and vi) primary scrambling code information. In the above system, the position information message is configured to be transmitted via a circuit call or a packet call.

Another aspect of the invention is a system for estimating a position of a mobile terminal, the system comprising: a base station configured to compute round trip time information of the mobile terminal; a base station controller configured to generate a position information message by packing the round trip time information and position related information of the mobile terminal; and a position estimating device configured to estimate a position of the mobile terminal based at least in part on the position information message.

The above system further comprises an operating and management (O&M) server, configured to maintain and repair the base station, wherein the O&M server is further configured to relay the position information message between the base station controller and the position estimating device. In the above system, the position related information comprises at least one of i) an identifier of a mobile switching center for a circuit call included in a mobile communication network, ii) an identifier of a base station controller, iii) an identifier of a base station, an identifier of a sector, iv) pseudo noise information, and v) primary scrambling code information. In the above system, the position information message is configured to be transmitted via a circuit call or a packet call.

Another aspect of the invention is a method of estimating a position of a mobile terminal in a position estimating device of a mobile communication system, the method comprising: receiving first round trip time information of the mobile terminal; receiving second round trip time information of a repeater; determining a service area of the mobile terminal based at least in part on comparison of the first and second round trip time information; and estimating a position of the mobile terminal based at least in part on at least one of latitude/longitude data of the repeater and the base station, connected to the repeater, and direction information of an antenna, based on the determined service area.

In the above method, the receiving of the first round trip time information comprises: receiving the first round trip time information computed in a repeater; generating a position information message by packing the first round trip time information with the position related information of the mobile terminal; and receiving the position information message from a base station controller or a packing message repeater. In the above method, the packing message repeater is an operating and management (O&M) server, configured to maintain and repair the base station. In the above method, the position related information comprises at least one of i) an identifier of a mobile switching center for a circuit call included in a mobile communication network, ii) an identifier of a base station controller, iii) an identifier of a base station, iv) an identifier of a sector, v) pseudo noise information, and vi) primary scrambling code information.

In the above method, the repeater is an optical repeater or an RF repeater, and wherein the second round trip time information is measured based at least in part on at least one of i) self delay of the base station, ii) self delay of the mobile terminal, iii) wireless link delay between the base station and the repeater, and iv) self delay of the optical repeater. In the above method, the determining is performed by comparing the first round trip time information, corresponding to at least one base station, with the second round trip time information corresponding to at least one repeater belonging to each base station.

Another aspect of the invention is a method of estimating a position of a mobile terminal in a mobile communication system, the method comprising: computing, at a base station, round trip time information of the mobile terminal; receiving, at a base station controller being in data communication with the base station, the round trip time information and position related information of the mobile terminal; generating, in at least one of the base station controller and an operating and management (O&M) server, a position information message by packing the round trip time information and the position related information of the mobile terminal; and estimating a position of the mobile terminal based at least in part on the position information message position of the mobile terminal.

In the above method, the position related information comprises at least one of i) an identifier of a mobile switching center for a circuit call included in a mobile communication network, ii) an identifier of a base station controller, iii) an identifier of a base station, iv) an identifier of a sector, v) pseudo noise information, and vi) primary scrambling code information.

Another aspect of the invention is a system for estimating a position of a mobile terminal in a position estimating device of a mobile communication system, the system comprising: means for receiving first round trip time information of the mobile terminal; means for receiving second round trip time information of a repeater; means for determining a service area of the mobile terminal based at least in part on comparison of the first and second round trip time information; and means for estimating a position of the mobile terminal based at least in part on at least one of latitude/longitude data of the repeater and the base station, connected to the repeater, and direction information of an antenna, based on the determined service area.

### BRIEF DESCRIPTION OF THE DRAWINGS

FIG. 1 illustrates a structure of a position estimating system.

FIG. 2 is a flow chart illustrating a position estimating process by using mobile switching center.

FIG. 3 is a flow chart illustrating a position estimating process by using packet data switching center.

FIG. 4 illustrates a connection structure between a typical base station and a repeater.

FIG. 5 illustrates a structure of a position estimating system in accordance with a first embodiment of the present invention.

FIG. 6 is a flow chart illustrating a process for transmitting position information by using a circuit call in accordance with an embodiment of the present invention.

FIG. 7 is a flow chart illustrating a process for transmitting position information by using a packet call in accordance with an embodiment of the present invention.

FIG. 8 illustrates a position estimating system in a second embodiment of the present invention.

FIG. 9 illustrates a position estimating system in a third embodiment of the present invention.

FIG. 10 illustrates a position estimating system in a fourth embodiment of the present invention.

FIG. 11 and FIG. 12 are flow charts illustrating a process for transmitting position information by using a circuit call in accordance with a second embodiment of the present invention through a fourth embodiment of the present invention.

FIG. 13 and FIG. 14 are flow charts illustrating a process for transmitting position information by using a packet call in accordance with a second embodiment of the present invention through a fourth embodiment of the present invention.

FIG. 15 illustrates a time delay in a service area of a base station.

FIG. 16 illustrates a time delay in a service area of an optical repeater.

FIG. 17 illustrates a time delay in a service area of an RF repeater.

FIG. 18 illustrates a structure of a service area of an optical repeater in accordance with one embodiment of the present invention.

FIG. 19 illustrates a structure of a service area of an RF repeater in accordance with one embodiment of the present invention.

FIG. 20 illustrates an example illustrating a position estimating method by using a round trip time in accordance with one embodiment of the present invention.

### DETAILED DESCRIPTION OF CERTAIN INVENTIVE EMBODIMENTS

Qualcomm has suggested the gpsOne (snap track) for a synchronous CDMA network. An OTDOA method, an A-GPS method, a method using a cell ID and a method using a round trip time (RTT) are provided for an asynchronous WCDMA network.

Here, the round trip time can be referred to as RTD (round trip delay) in the synchronous CDMA network and as RTT (round trip time) in the asynchronous WCDMA network.

The gpsOne mainly employs GPS measuring data, PN phase, cell ID and RTD, which are measured by a mobile terminal and provided to a system.

In the case of a GPS (global positioning system) method, an AFLT (advanced forward link trilateration) method, a hybrid method, a position is estimated based on data, measured by the mobile terminal, according to a message (standard: 3GPP2 C.S0022-A v1.0) defined by the standard

However, in the case of a cell sector round trip delay (safety net), it is to use internal information of a system (particularly, a base station), the clear standard or using method of which has not been defined in a standard.

Beside that, although there are developed only items using the cell sector round trip delay, today's technology is not reached to the actual realization and application of the cell sector round trip delay.

Meanwhile, when it comes to a position estimating method, the position can be most exactly estimated by using GPS measuring data of a mobile terminal. However, the mobile terminal must be limitedly located at a range capable of receiving a GPS signal of a satellite.

In the case of estimating the position through a pseudo noise phrase, since a service is performed by an only active set having one mobile terminal in a traffic status, there is provided one reference pseudo noise (RefPN) itself. This causes to make it difficult to secure the PN phase for estimating the position.

In the case of round trip time information, information generated in a receiving demodulation unit of a base station can be extracted from a mobile terminal in a traffic status having one active set. Accordingly, the mobile terminal, which is located at an area not capable of performing the GPS service, or which performs a service through only one active set, can estimate an exacter position by using the round trip information.

However, when it comes to the today's mobile communication network, the standard, which an equipment estimating the position of the mobile terminal can receive the round trip time information, has not been determined. Accordingly, the above position estimating device has estimated the position by using the Cell ID information, the GPS measuring data, PN phase information, provided by the base station. This causes to generate a lot of errors.

A method using a cell ID, a method using the cell ID and a RTT, an OTDOA method and an A-GPS method are provided for an algorithm and detailed position estimating method in the WCDMA network.

The difficulty of realization makes the OTDOA method gradually unused. Accordingly, the WCDMA can employ the method using a cell ID, the A-GPS method and a hybrid method of combinations thereof.

The A-GPS method uses the GPS measuring data measured by the mobile terminal. Although the A-GPS method can estimate a exactest position, the terminal must be limitedly located at a range capable of receiving a GPS signal of a satellite.

Moreover, using the only cell ID makes the position estimated considerably inexactly. To complement this inexact estimation, a round trip time can be used.

The round trip time information, which is generated by the receiving demodulation unit of the base station, can be extracted by the mobile terminal in the traffic status having one active set.

Accordingly, the mobile terminal, which is located at an area not capable of receiving the GPS service, or which performs a service through only one active set, can estimate an exacter position by using the round trip information than the only cell ID.

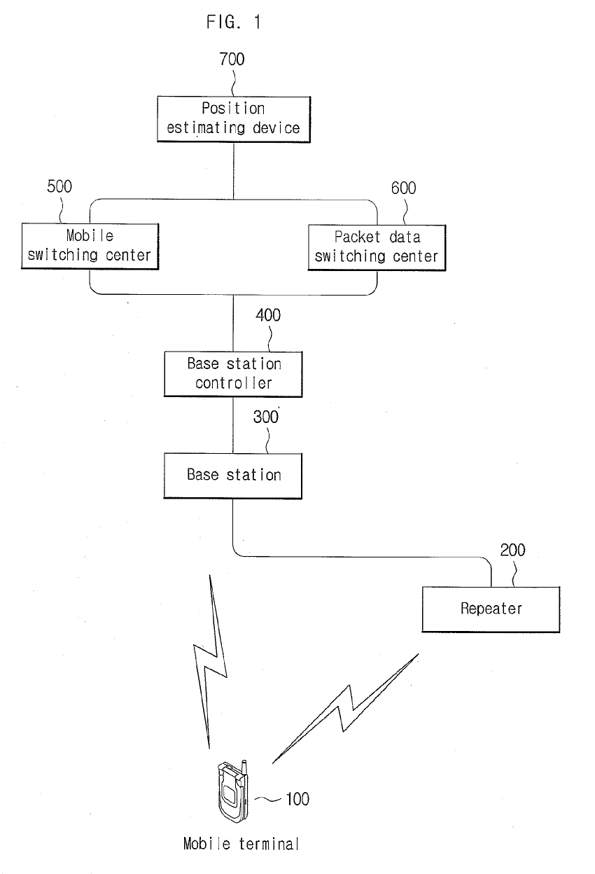

FIG. 1 illustrates a structure of a position estimating system. Referring to FIG. 1, the position estimating method is divided into a first method, passing through a mobile switching center 500 performing a voice service, and a second method, passing through a packet data switching center 600 performing a data service.

The first method passing through the mobile switching center 500 finds out a position of a mobile terminal through a registration order requesting operation or a paging operation.

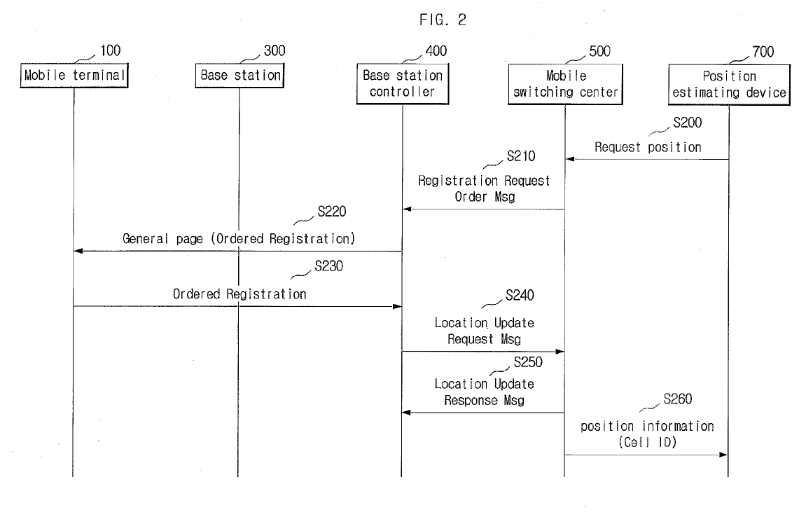

FIG. 2 is a flow chart illustrating a position estimating process by using mobile switching center. Referring to FIG. 2, if a position estimating device 700 requests a position to the mobile switching center 500 in a step represented by S200, the mobile switching center 500 transmits a position registration request order message to a base station controller 400 in a step represented by S210.

The base station controller 400 transmits a paging signal to a mobile terminal 100 in a step represented by S220 (ordered registration). Here, the paging signal is a position registration request signal by a command of the base station controller 400.

The mobile terminal 100 transmits a paging response signal to the base station controller 400 in a step represented by S230 (ordered registration).

Then, the base station controller 400 transmits a position update request message of the mobile terminal 100 to the mobile switching center 500 in a step represented by 240). The mobile switching center 500 transmits a response message of the position update request message to the base station controller 400 in a step represented by S250).

The base station controller 400 transmits cell ID information, to which the mobile terminal 100 pertains, to the mobile switching center 500.

The mobile switching center 500 transmits cell ID information to the position estimating device 700, and the device 700 recognizes a position of the base station 300, to which the mobile terminal 100 belongs, through the cell ID information.

A position information service, computed by the aforementioned method, is mainly used for a service that does not request high-level exactitude.

In the meantime, the second method, passing through the packet data switching center 600, searches the position of the mobile terminal 100 based on the message measured by the mobile terminal 100.

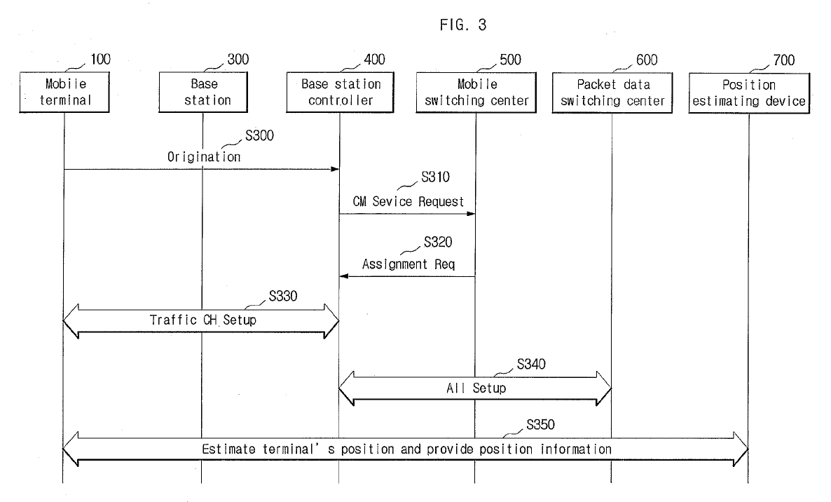

FIG. 3 is a flow chart illustrating a position estimating process by using packet data switching center. Referring to FIG. 3, the mobile terminal 100 an initializing signal to the base station controller 400 in a step represented by S300, and the base station controller 400 requests connection management to the mobile switching center 500 in a step represented by S310.

After that, the mobile switching center 500 requests channel allotment to the base station controller 400 in a step represented by S320. Accordingly, a traffic channel between the base station controller 400 and the mobile terminal 100 is set in a step represented by S330.

After the traffic channel is set, a channel for a packet data service between the base station controller 400 and the packet data switching center 600 in a step represented by S340 (All setup).

Then, the mobile terminal 100 transmits information for position estimation of the mobile terminal, for example, GPS measuring data and cell ID, to the position estimating device 700, and the device 700 provides the estimated position information to the mobile terminal 100 in a step represented by S350.

FIG. 3 illustrates the method that data access is performed through data call access via data paging, data access through SMS paging, data access by the request of a subscriber, and then, information for estimating a position is measured by the mobile terminal 100 and the measured information passes through the packet data switching center 600 and is transmitted to the device 700.

However, the device 700 acquires only cell ID information in the case of passing through the mobile switching center 500 and only GPS measuring data and cell ID information in the case of packet data switching center 600. In other words, the standard, for transmitting round trip time information to the device 700, has not been defined yet.

Meanwhile, although the round trip time information is used, in the case of estimating a position of the mobile terminal, it is difficult to prevent a lot of errors from being generated.

For exact position estimation of the mobile terminal, it is most ideal that a mobile communication network is constructed to include an only base station.

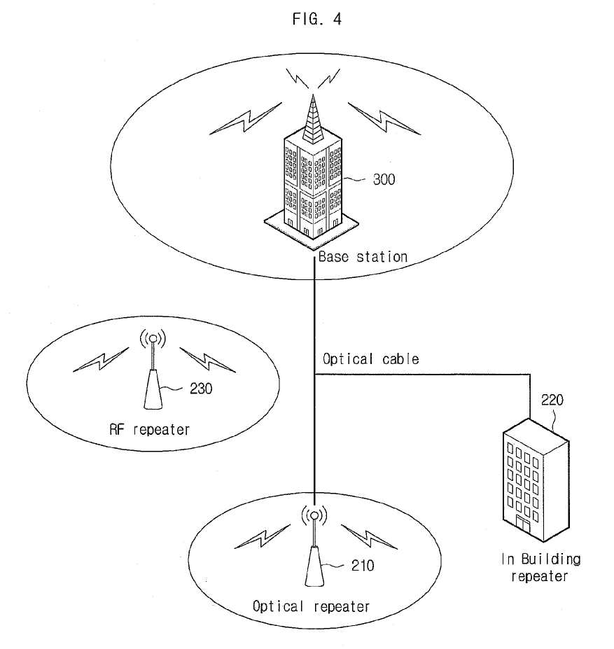

However, due to the cost of equipment and other reasons, the mobile communication network is constructed to include the base station 300 and repeaters 210, 220 and 230, as illustrated in FIG. 4. Typically, 2 to 5 optical repeaters 210 are connected for service coverage expansion. Also, an in-building repeater 220 and an RF repeater 230 are built in each shadow area.

Since the optical repeater 210 is connected with the base station 300 through a optical cable, it can be analyzed that the factor delaying a signal is caused by the delay of the optical cable and the self delay of the optical repeater 210.

In the case of the RF repeater 230, the service can be provided through the base station and the optical repeater. Accordingly, if the service is provided through the signal of the base station, a signal delaying factor of the RF repeater can be caused by the self delay of the RF repeater. Also, if the service is provided through the signal of another repeater, the delay factor can be caused by various delay factors such as a delay caused between the RF repeater and another repeater, the self delay of the RF repeater and the self delay of another repeater.

Particularly, in the case of an optical repeater 210a, since the optic cable between the base station 300 and the optical repeater 210 is not installed as a direct path, it is difficult to estimate the delay. Accordingly, a lot of errors are generated in the round trip time itself when a position of a subscriber's terminal is estimated in a repeater area beyond the direct service area of the base station. This leads to many errors generated in a position estimating value.

Hereinafter, some embodiment of the present invention will be described with the accompanying drawings.

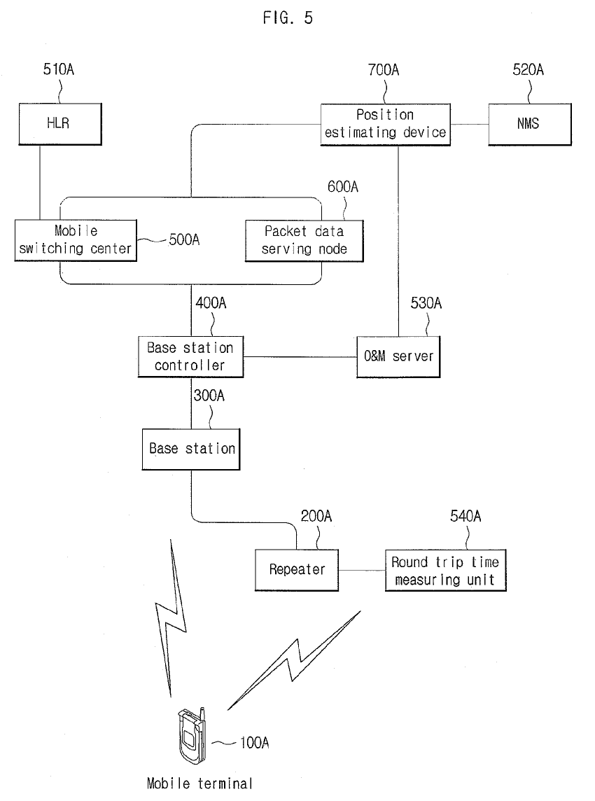

FIG. 5 illustrates a structure of a position estimating system in accordance with a first embodiment of the present invention.

Although FIG. 5 assumes that a position estimating system in accordance with a first embodiment of the present invention is the position estimating system in a CDMA network, it is well-known to any person of ordinary skill in the art that the present invention can be applied to another mobile communication system, for example, a WCDMA network.

As illustrated in FIG. 5, the position estimating system can include a repeater 200A, a base station 400A, a base station controller 400A, a mobile switching center (MSC) 500A, a home location register (HLR) 510A, a packet data serving node (PSDN) 600A, a position estimating device 700A, a network management system (NMS) 520A and an operating and management (O&M) server 530A a round trip time measuring unit 540A. The base station 300A performs a wireless access function to the mobile terminal 100A and a wire or wireless access function to the mobile terminal 100A and the base station controller 400A. Although FIG. 5 illustrates one base station 300A, it is well-known to any person of ordinary skill in the art that there can be provided a plurality of base stations.

The base station controller 400A, which is located between the base station 300A and the mobile switching center 500A, managing and controlling the base station 300A.

The mobile switching center 500A, which provides a mobile communication service to a mobile communication subscriber, performs line exchange between subscribers, an input and output relay processing, handoff and roaming and manages a visitor location register (VLR) database.

The home location register 510A is connected to the mobile switching center 500A and stores information related to the mobile terminal subscriber.

The packet data serving node 600A, which provides a packet data service to the mobile terminal, is connected to the base station controller 400A and performs setting, maintaining and completing processes of a point-to-point protocol (PPP) session of the subscriber.

The position estimating device 700A, which is connected to the packet data serving node 600A and the mobile switching center 500A, can include position determination entry (PDE).

The device 700A, which receives a GPS signal, receives information related to a position of the mobile terminal 100A by using circuit call or a packet call and estimates the position of the mobile terminal 100A.

The network management system 520A manages position information of the base station and the repeater, included in the mobile communication network, and direction information of an antenna. Here, the position information can be related to latitude and longitude.

The position estimating device 700A can estimate the position of the mobile terminal 100A by referring to the latitude and longitude information of the network management system 520A.

The O&M server 530A, which is connected to the base station controller 400A, maintaining and repairing the base station 300A and the base station controller 400A.

The round trip time measuring unit 540A, which is connected to the repeater 200A, measures a self round trip time of the repeater 200A and periodically transmits the measured self round trip time to the base controller 400A.

In the case of setting a call between the mobile terminal 100A and the base station controller 400A, the base station 300A computes round trip time information of the mobile terminal 100A and periodically transmits the computed information to the base controller 400A.

Here, the round trip time information refers to the information related to electric wave delay generated while the mobile terminal 100A, the base station 300A and the repeater 200A wirelessly communicate signals with one another. The round trip time information includes self delay of mobile terminal 100A, wireless rink delay between the mobile terminal 100A and the base station 300A or the repeater 200A and self delay of the repeater 200A.

The round trip time information of the mobile terminal is generated in at least one demodulation unit of the base station corresponding to a service area of the mobile terminal 100A. Generally, the standard, which the round trip time information is transmitted to the position estimating device 700A, was not defined.

In case that the base station controller 400A receives round trip time information of the mobile terminal from the base station 300A in order to transmit the round trip time information to the position estimating device 700A, the present invention generates a position information message by packeting the received round trip time information and position related information of the mobile terminal.

Alternatively, the base station controller 400A can transmit the received round trip time information and position related information of the mobile terminal, respectively, to the O&M server 530A, and the O&M server 530A can generate a position information message by packeting the position related information of the mobile terminal.

The following Table 1 shows the information included in the position information message.

TABLE 1
Position information message

| Information | Details | Remark |
|---|---|---|
| Msg ID | Indicating message type | For identifying PSMM/PPSMM |
| Seq ID | Serial number generated in each job | Serial number of PSMM/PPSMM |
| Time | Time when message is generated | |
| Mobile ID | Terminal MDN or IMSI | |
| REF_PN | Reference PN | Acquiring in PSMM or PPSMM |
| Number of PN | Numbers of measured PN | Acquiring in PSMM or PPSMM |
| MSC[0] | NID number (identifying mobile | PN is determined by using PN phase, |
| | switching center) possessed by system | acquired in terminal, and then is |
| | | acquired through neighbor list stored |
| | | in system |
| BSC[0] | BSC number possessed by system | |
| BTS[0] | BTS number possessed by system | |
| SEC[0] | Sector number possessed by system | |
| PN[0] | PN possessed by system | |
| PN_PHASE[0] | Information acquired in terminal | Acquiring in PSMM or PPSMM |
| PN_Strength[0] | Information acquired in terminal | Acquiring in PSMM or PPSMM |
| RTD[0] | Round Trip Delay measured by system | Acquiring in BTS |
| . | . | . |
| . | . | . |
| . | . | . |
| NID[n] | NID number (identifying mobile | PN is determined by using PN phase, |
| | switching center) possessed by system | acquired to terminal, and then is |
| | | acquired through neighbor list stored |
| | | in system |
| BSC[n] | BSC number possessed by system | |
| BTS[n] | BTS number possessed by system | |
| SEC[n] | Sector number possessed by system | |
| PN[n] | PN possessed by system | |
| | Information acquired to terminal | |
| PN_PHASE[n] | Information acquired in terminal | Acquiring in PSMM or PPSMM |
| PN_Strength[0] | Information acquired in terminal | Acquiring in PSMM or PPSMM |
| RTD[n] | Round Trip Delay measured by system | Acquiring in BTS |

As illustrated in Table 1, the position information message in accordance with the present invention includes information related to the round trip time (0 through n) according to an active set (i.e. a set of the base stations connected to the mobile terminal) of the mobile terminal.

The position information message also includes an identifier of mobile switching center, to which the mobile terminal 100A pertains, an identifier of a base station controller, an identifier of a base station, an identifier of a sector and an identifier of pseudo noise.

In accordance with the present invention, the position information message, generated in the base station controller 400A, can pass through a packing message repeater unit and be transmitted to the position estimating device 700A.

Beside that, the position information message, generated in the O&M server through each information received from the base station controller 400A, can be transmitted to the position estimating device 700A.

Here, the packed message repeater unit, which is the element for generating and relaying a position information message and transmitting it to the device 700A, can be preferably the O&M server 530A.

The reason that the present invention uses the O&M server 530A is that a mobile communication operator typically uses an exclusive line for concentrating data of the O&M server 530A on the center part already.

In accordance with the present invention, the position information message can be transmitted to the device 700A by using a circuit call for a voice service and a packet call for a data service.

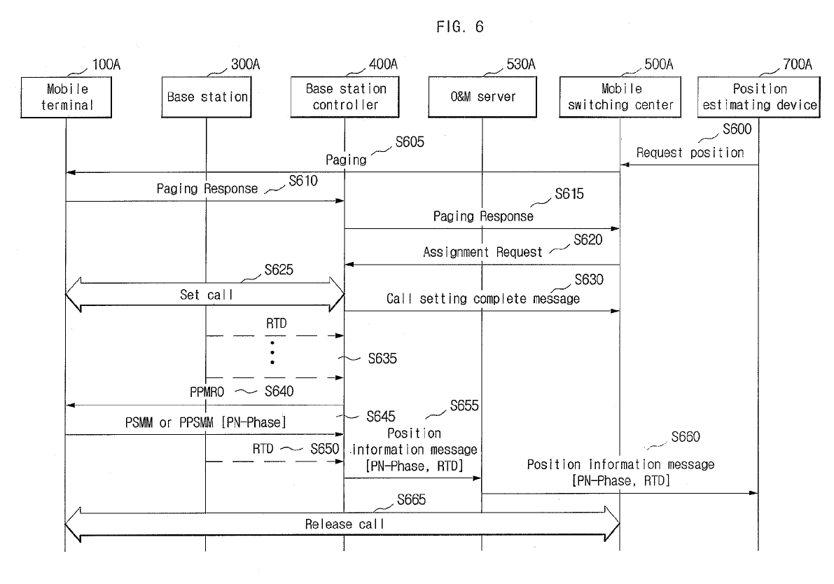

FIG. 6 is a flow chart illustrating a process for transmitting position information by using a circuit call in accordance with an embodiment of the present invention.

Referring to FIG. 6, in case that the position estimating device 700A requests a position to the mobile switching center 500A in a step represented by S600A, the mobile switching center 500A transmits a paging signal to the mobile terminal 100A in a step represented by S605.

Then, the mobile terminal 100A transmits a paging response signal to the base station controller 400A in a step represented by S610, and the base station controller 400A transmits the response signal to the mobile switching center 500A in a step represented by S615 (paging response transmittance).

The mobile switching center 500A requests the allotment to the base station controller 400A in a step represented by S620, and the base station controller 400A sets a call with the mobile terminal 100A according to the allotment request in a step represented by S625. After setting the call, the base controller 400A transmits a call setting complete message to the mobile switching center 500A in a step represented by S630.

After setting the call, the base station 300A computes round trip time information of the mobile terminal and periodically transmits the computed round trip time information to the base station controller 400A in a step represented by S635.

The base station controller 400A requests a periodic pilot measurement report order (PPMRO) to the mobile terminal 100A.

The following Table 2 shows the information included in the PPMRO.

TABLE 2
PPMRO: Periodic Pilot Measurement Report Order

| Order Specific Field | Length (bits) |
|---|---|
| ORDQ | 8 |
| MIN_PILOT_PWR_THRESH | 5 |
| MIN_PILOT_EC_IO_THRESH | 5 |
| RESERVED | 6 |

In response to the PPMRO, the mobile terminal 100A transmits a pilot strength measurement message (PSMM) or a periodic pilot strength measurement message (PPSMM) to the base station controller 400A in a step represented by S645.

As shown in following Table 3 and Table 4, the PSMM and PPSMM include PN-phase.

TABLE 3

| | |
|---|---|
| Field | Length (bits) |

PSMM: Pilot Strength Measurement Message

| | |
|---|---|
| MSG_TYPE (00000101) | 8 |
| ACK_SEQ | 3 |
| MSG_SEQ | 3 |
| ACK_REQ | 1 |
| ENCRYPTION | 2 |
| REF_PN | 9 |
| PILOT_STRENGTH | 6 |
| KEEP | 1 |

Zero or more occurrence of the following record:

| | |
|---|---|
| PILOT_PN_PHASE | 15 |
| PILOT_STRENGTH | 6 |
| KEEP | 1 |
| RESERVED | 0-7 (as needed) |

TABLE 4

| | |
|---|---|
| Field | Length (bits) |

PPSMM: Periodic Pilot Strength Measurement Message

| | |
|---|---|
| MSG_TYPE (00010101) | 8 |
| ACK_SEQ | 3 |
| MSG_SEQ | 3 |
| ACK_REQ | 1 |
| ENCRYPTION | 2 |
| REF_PN | 9 |
| PILOT_STRENGTH | 6 |
| KEEP | 1 |
| SF_RX_PWR | 5 |
| NUM_PILOT | 4 |

NUM_PILOT occurrence of the following record:

| | |
|---|---|
| PILOT_PN_PHASE | 15 |
| PILOT_STRENGTH | 6 |
| KEEP | 1 |
| RESERVED | 0-7 (as needed) |

The base station 400A periodically receives the round trip time information from the base station 300A in a step represented by S650 and generates a position information message, including a pseudo noise phase and round trip time information, to transmit it to the O&M server 530A in a step represented by S655.

As described above, the position information message of the present invention can further include the identifiers of mobile switching center, base station controller and base station as well as the pseudo noise phase and the round trip time information.

The O&M server 530A transmits the generated or received position information message to the device 700A in a step represented by S660.

The position estimating device 700A of the present invention can estimate the position of the mobile terminal by particularly using the round trip time information of the mobile terminal, included in the position information message.

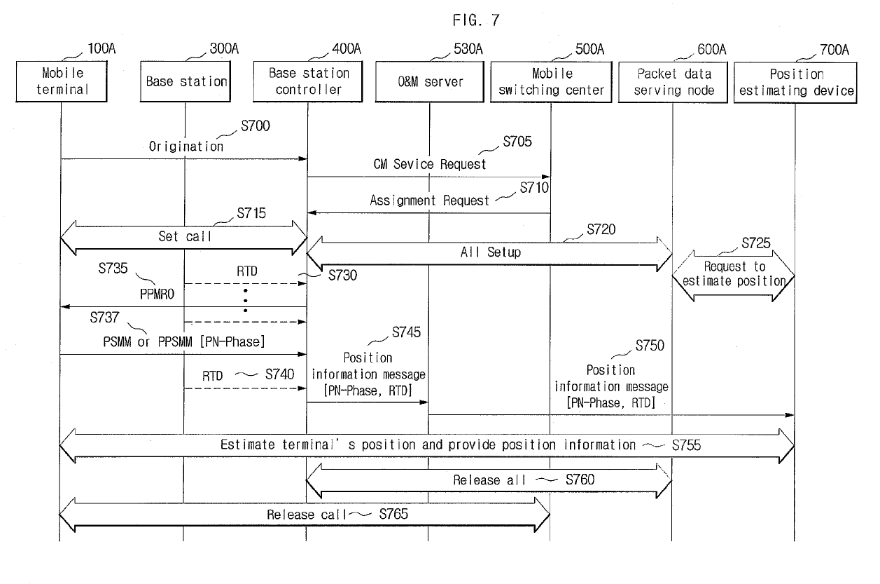

FIG. 7 is a flow chart illustrating a process for transmitting position information by using a packet call in accordance with an embodiment of the present invention.

Referring to FIG. 7, the mobile terminal 100A transmits an initializing signal to the base station controller 400A in a step represented by S700A, and the base station controller 400A requests connection management to the mobile switching center 500A in a step represented by S705.

Then, the mobile switching center 500A requests channel allotment to the base station controller 400A in a step represented by S710, and thus, a traffic channel between the base station controller 400A and the mobile terminal 100A is set in a step represented by S715.

After the traffic channel is set, a channel for a packet data service is set between the base station controller 400A and the packet data serving node 600A in a step represented by S720 (All setup).

As described above, if the call is set between the mobile terminal 100A and the base station controller 400A, the base station 300A periodically receives round trip time information of the mobile terminal and transmits it to the base station controller in a step represented by S730.

The base station 400A, as illustrated in FIG. 6, transmits a PPMRO to the mobile terminal 100A in a step represented by S735 and the mobile terminal 100A transmits a PSMM or PPSMM, including a pseudo noise phase, to the base station controller 400A in a step represented by S737.

At the same time, the base station controller 400A receives the round trip time information from the base station 300A in a step represented by S740, and the base station controller 400A generates position information message including the same information as shown in Table 1 or transmits each information to the O&M server 530A in a step represented by S745.

The O&M server 530A transmits the position information message, generated by the base station controller 400A, to the position estimating device 700A in a step represented by S750. At this time, alternatively, the base station controller 400A can transmit only round trip time information and position information message of the mobile terminal, and the O&M server 530A can generate a position information message by packing the information.

In addition to the position information message, the position estimating device 700A can receive GPS data, for example, measured in the mobile terminal 100A, according to the standard of IS-801.

In the case of receiving data for estimating a position, the device 700A estimates the position of the mobile terminal 100A.

Then, the base station 400A and the packet data serving node 600A release A11 setup in a step represented by S760, and the mobile terminal 100A and the mobile switching center 500A release the call in a step represented by S765.

As described above, the base station controller 400A of the present invention packs the round trip time information of the mobile terminal and other position related information together. Since the O&M server 530A transmits the packed message to the device 700A, the device 700A can more exactly compute the position of the mobile terminal by using the round trip time information.

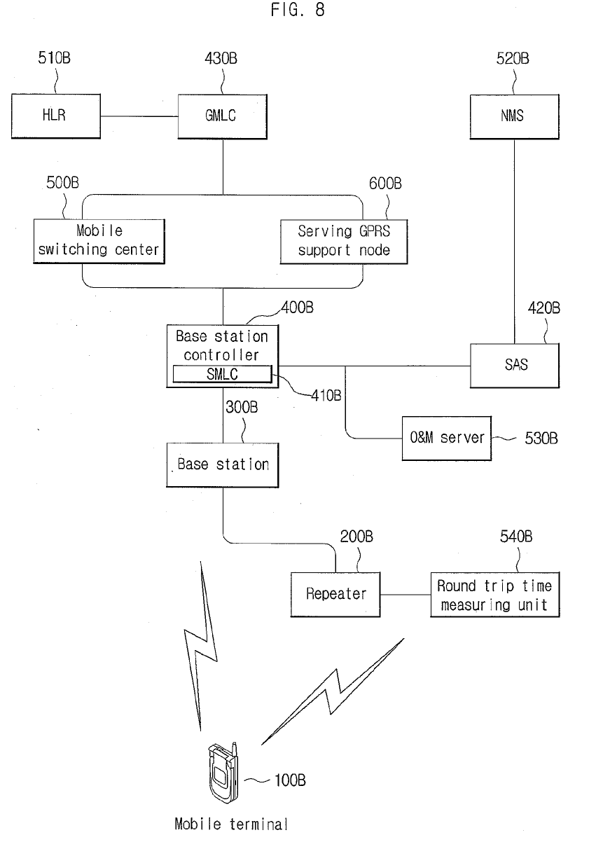

FIG. 8 illustrates a position estimating system in a second embodiment of the present invention. As illustrated in FIG. 8, the position estimating system can include the base station 300B, at least one repeater 200B belonging to the base station, a base station controller 400B, an SMLC 410B, included in the base station controller 400B, an SAS 420B, connected to the base station controller 400B, the O&M server 530B, the NMS 520B, an mobile switching center 500B, an serving GPRS support node (SGSN) 600B, a GMLC 430B and the HLR 510B.

The base station 300B performs a wireless access function to the mobile terminal 100B and a wire or wireless access function to the mobile terminal 100B and the base station controller 400B.

Also, in case that the mobile terminal 100B is in a traffic state, the base station 300B transmits round trip time information of the mobile terminal 100B to the base station controller 400B.

Although FIG. 8 illustrates one base station 300B, it is well-known to any person of ordinary skill in the art that there can be provided a plurality of base stations.

The base station controller 400B, which is located between the base station 300B and the mobile switching center 500B, managing and controlling the base station 300B.

The mobile switching center 500B, which provides a mobile communication service to a mobile communication subscriber, performs line exchange between subscribers, an input and output relay processing, handoff and roaming and manages a visitor location register (VLR) database

The serving GPRS support node 600B provides protocol linking, on an IP basis for conformity with the existing Internet network, to receive a packet switching service. For this, the serving GPRS support node 600B is connected to a plurality of base station controllers 400B and takes charge of the mobility and packet session management of the mobile terminal 100B.

The O&M server 530B maintaining and repairing the base station controller 400B. The gateway mobile location center (GMLC) 430B is connected to the HLR 510B, storing information related to a subscriber. In the case of requesting a position of the mobile terminal 100B, the GMLC 430B recognizes the mobile switching center 500B or the serving GPRS support node 600B, to which the mobile terminal 100B belongs, through the HLR 510B and transmits location request information to the recognized mobile switching center 500B or serving GPRS support node 600B.

In accordance with an embodiment of the present invention, in the case of requesting the position, the position estimating device 700 estimates the position of the mobile terminal by using round trip time information of the mobile terminal, round trip time information of the repeater and information stored in the NMS 520B.

The position estimating device of the present invention can be the SAS 420B, the SMLC 410B and a position estimating apparatus 700, located outside a network.

FIG. 8 illustrates the system that the SAS 420B, connected to the base station controller 400B, estimates the position of the mobile terminal. In accordance another embodiment of the present invention, the SAS 420B uses round trip time information of the repeater, measured in a round trip time measuring unit 540B connected to the repeater, as well as the round trip time information of the mobile terminal and is linked with the NMS 520B, to estimate the position of the mobile terminal.

The NMS 520B stores latitude/longitude of the base station, antenna direction and latitude/longitude of the repeater and generally manages the mobile terminal by using the information, the SAS 420B estimates the position of the mobile terminal by using the information.

Below is shown Table 1 including the latitude/longitude of the base station and direction information of the antenna.

TABLE 5
Example of latitude/longitude of the base station, PSC and direction
information of the antenna

| | | | | | BASE | | | | | | | |
|---|---|---|---|---|---|---|---|---|---|---|---|---|
| EQUIP NAME | LATITUDE | LONGITUDE | MSC | RNC | STATION | SEC | APSC | A-Angle | BPSC | B-Angle | GPSC | G-Angle |
| SL0582X | 37-33-37.778 | 126-58-37.967 | 1 | 1 | 1 | 3 | 110 | 40 | 278 | 130 | 446 | 270 |
| SL0004X | 37-33-41.738 | 126-58-58.488 | 1 | 2 | 2 | 3 | 68 | 20 | 236 | 120 | 404 | 250 |
| SL0566X | 37-33-39.207 | 126-58-48.171 | 1 | 3 | 3 | 2 | 50 | 10 | 218 | 170 | — | |
| SL0300X | 37-33-49.077 | 126-59-05.933 | 1 | 4 | 4 | 3 | 34 | 20 | 202 | 160 | 370 | 290 |

Typically, the SAS 420B estimates the position based on the GPS information positioned in the mobile terminal. Through a positioning calculation application part (PCAP) signaling (3GPP TS 25.453, referring to below Table 6), the SAS 420B can estimate the position by using the round trip time information,

TABLE 6
Position Calculation Req TERMINAL st (3GPP TS 25.453)

| | | | IE type and | Semantics | | Assigned |
|---|---|---|---|---|---|---|
| IE/Group Name | Presence | Range | reference | description | Criticality | Criticality |
| Message Type | M | | 9.2.2.24 | | YES | reject |
| Transaction ID | M | | 9.2.2.28 | | — | |
| Initial Terminal | M | | Geographical | | YES | reject |
| Position Estimate | | | Area9.2.2.6 | | | |
| Measured Results | | 1 . . . | | | GLOBAL | reject |
| | | <maxNo | | | | |
| | | OfSets> | | | | |
| >GPS Measured | M | | 9.2.2.12 | | — | |
| Results | | | | | | |
| Measured Cell | | | | | | |
| Inform | | | | | | |

Also, the SAS 420B estimates the position by using the round trip time information of the repeater. This will be described below in detail.

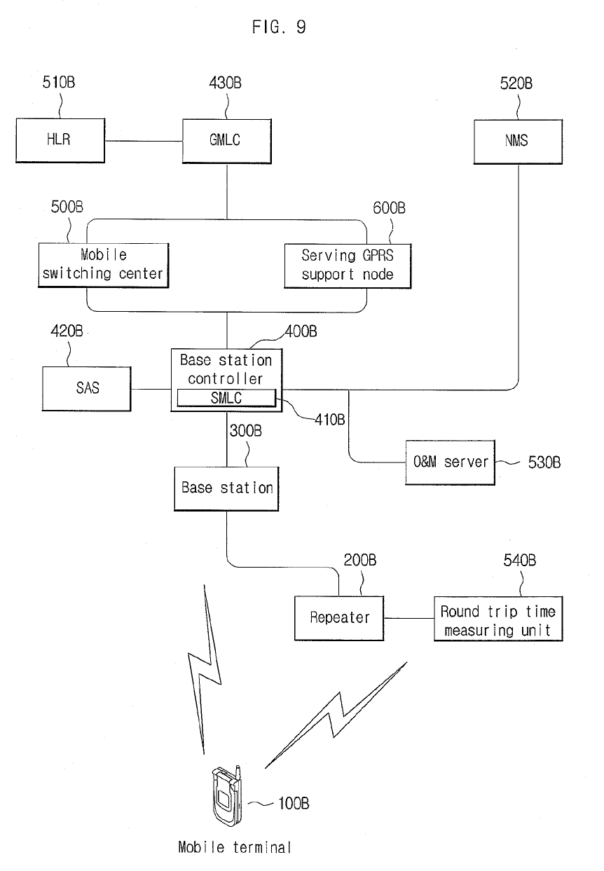

FIG. 9 illustrates a position estimating system in a third embodiment of the present invention and illustrates the position estimating system according to a WCDMA network. FIG. 9 illustrates the case that the position estimating device is a serving mobile location center (SMLC) 810 included in the base station controller 400B.

The SMLC 410B can estimate the position of the mobile terminal 100B by using cell ID and round trip time information.

In accordance with another embodiment of the present invention, the SMLC 410B uses latitude/longitude of the base station and the repeater and direction information of the antenna by linking with NMS 520B and estimates the position of the mobile terminal by using the round trip time information of the repeater, measured in the round trip time measuring unit 540B.

For this, the present invention defines a predetermined conformity standard between the SMLC 410B and the NMS 520B such that the SMLC 410B can use the latitude/longitude and direction information of the antenna.

As illustrated in FIG. 8 and FIG. 9, in case that the SAS 420B or the SMLC 410B computes the position of the mobile terminal 100B, the computed position is transmitted to the GMLC through the mobile switching center 500B and the serving GPRS support node 600B.

Meanwhile, in accordance with another embodiment of the present invention, the position of the mobile terminal can be estimated by a position estimating apparatus located outside the WCDMA network.

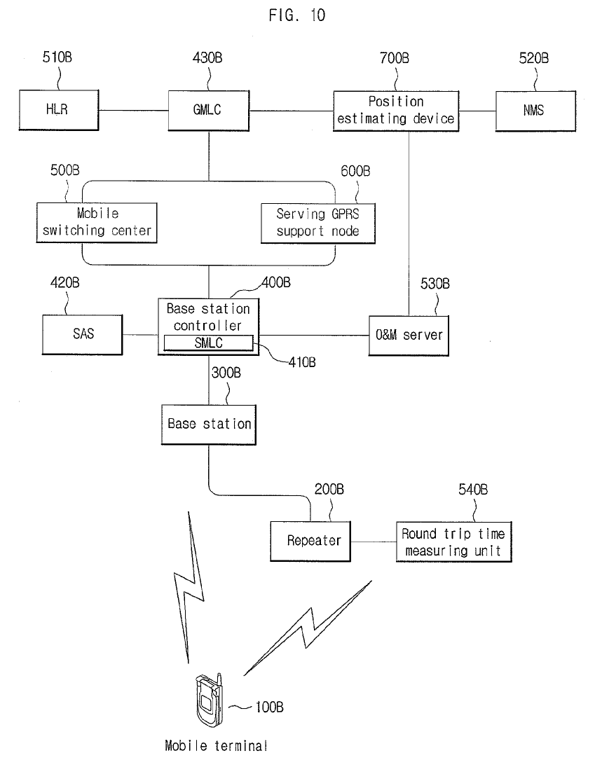

FIG. 10 illustrates a position estimating system in a fourth embodiment of the present invention. FIG. 10 illustrates a position estimating system according to a WCDMA network.

In the system of FIG. 10, the round trip time information and position related information of the mobile terminal, provided by the base station 300B, must be provided to the position estimating device 700.

Here, the position related information can include at least one of an identifier of mobile switching center, another identifier of base station controller, another identifier of base station, another identifier of sector and PSC information.

In case that the mobile terminal 100B is in a traffic state, the base station controller 400B receives the round trip time information of the mobile terminal from the base station 300B and the position related information of the mobile terminal from the mobile terminal 100B.

At this time, the base station controller 400B generates a position information message by packing the round trip time information and the position related information of the mobile terminal 100B.

The position information message can pass through the O&M server 530B and be transmitted to the position estimating device 700.

The base station controller 400B can transmit the round trip time information and the position related information to the O&M server 530B, and the O&M server 530B can generate a position information message by packing the transmitted round trip time information and position related information.

The position information of the present invention can include information of the following Table 7.

TABLE 7
Position information message

| Information | Details | Remark |
|---|---|---|
| Msg ID | Indicating message type | MR |
| Seq ID | Serial number generated in each job | Serial number of MR |
| Time | Time when message is generated | — |
| Mobile ID | Terminal MDN or Terminal | Can be replaced with Job |
| | | processor number that system |
| | | manages |
| FA | Terminal service frequency | — |
| BEST_PSC | Reference PSC | — |
| Number of PSC | Numbers of Measured PSC | — |
| MSC[0] | CN number possessed by system | Compute CN/RCN/Base |
| RNC[0] | RNC number possessed by system | station/SEC values by using |
| Base station[0] | Base station number possessed by system | PSC, acquired in terminal and |
| SEC[0] | Sector number possessed by system | Cell ID |
| PSC[0] | PSC possessed by system | |
| RTT[0] | System internal information | Base station providing |
| | | Information |
| . | . | . |
| . | . | . |
| . | . | . |
| MSC[n] | CN number possessed by system | Compute CN/RCN/Base |
| RNC[n] | RNC number possessed by system | station/SEC values by using |
| Base station[n] | Base station number possessed by system | PSC, acquired in terminal and |
| SEC[n] | Sector number possessed by system | Cell ID |
| PSC[n] | PSC possessed by system | |
| RTT[n] | System internal information | Base station providing |
| | | information |

As illustrated in Table 7, the position information message in accordance with the present invention includes information related to the round trip time (0 through n) according to an active set of the mobile terminal.

The reason that the present invention uses the O&M server 530B is that a mobile communication operator typically uses an exclusive line, for concentrating data of the O&M server 530B on the center part, already.

In accordance with the present invention, the position information message can be transmitted to the device 700 by using a circuit call for a voice service and a packet call for a data service.

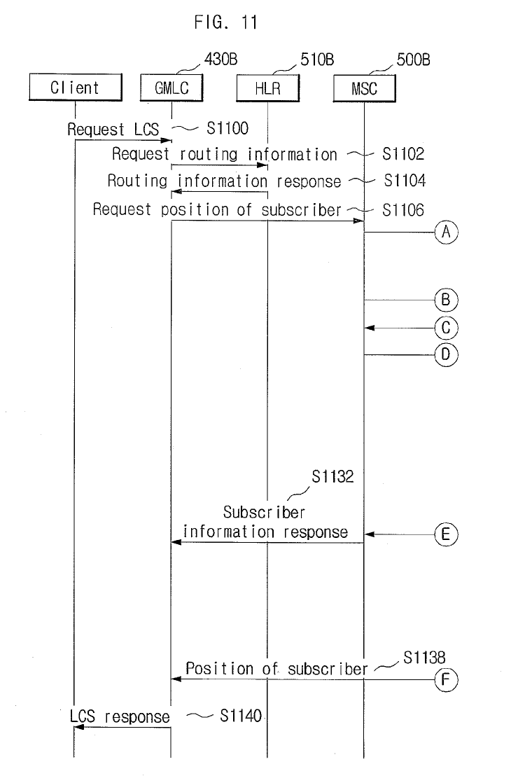

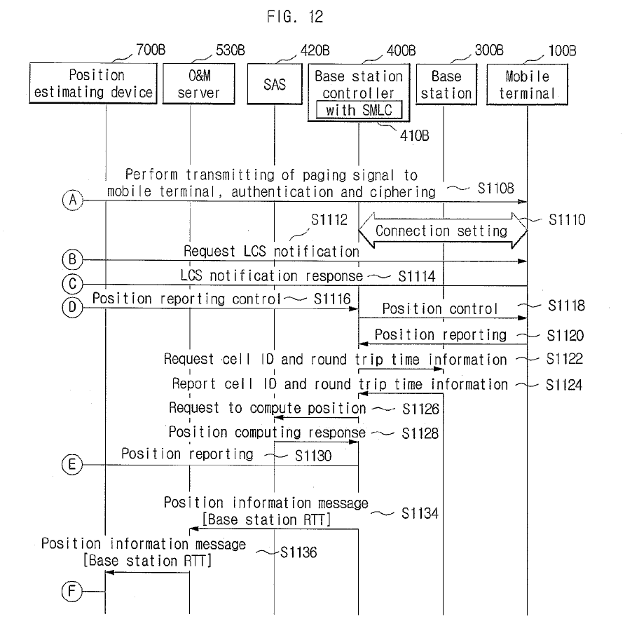

FIG. 11 and FIG. 12 are flow charts illustrating a process for transmitting position information by using a circuit call in accordance with a second embodiment of the present invention through a fourth embodiment of the present invention.

Referring to FIG. 11 and FIG. 12, in case that a client requests a position of a predetermined mobile terminal, the GMLC 430B receives a location service (LCS) request in a step represented by S1100B and transmits a request of routing information for requesting a location service to the HLR 510B in a step represented by S1102.

The request of the routing information is to recognize the mobile switching center, to which the mobile terminal belongs.

The HLR 510B transmits information related to the mobile switching center, to which the mobile terminal 100B belongs, to the GMLC 430B in a step represented by S1104, and the GMLC 430B requests a position of a subscriber (a mobile terminal) to the mobile switching center 500B in a step represented by S1106.

The mobile switching center 500B performs the transmitting of a paging signal to the mobile terminal 100B, authentication and ciphering in a step represented by S1108, and the connection between the base station controller 400B and the mobile terminal 100B is allowed to be set in a step represented by S1110.

Then, the mobile switching center 500B transmits an LCS notification invoke to the mobile terminal in a step represented by S1112 and receives a corresponding response signal in a step represented by S1114.

The mobile switching center 500B transmits a location reporting control message to the base station controller 400B in a step represented by S1116.

When receiving the location reporting control message, the base station controller 400B transmits a measurement control message to the mobile terminal in a step represented by S1118.

The mobile terminal 100B transmits position data, positioned by the mobile terminal, to base station controller 400B through a measurement report message in a step represented by S1120.

In accordance with the present invention, in the case of estimating a position of the mobile terminal by using cell ID and round trip time information, and the base station controller 400B requests cell ID and round trip time information of the mobile terminal to the base station controller 400B in a step represented by S1122. The base station 300B transmits the cell ID and the round trip time information of the mobile terminal to the base station controller 400B in a step represented by S1124.

At this time, in case that the information transmitted from the mobile terminal is GPS information, the SAS 420B computes the position of the mobile terminal by using the GPS information positioned from the base station controller 400B, and the computed information passes through the mobile switching center and is transmitted to the GMLC 430 in steps represented by S1126 through S1132.

In the case using the round trip time of the mobile terminal, the base station controller 400B generates a position information message by packing the position related information (e.g. cell ID information) and the round trip time information of the mobile terminal and transmits the generated position information message to the O&M server 530B in a step represented by S1134.

The position information message is transmitted to the position estimating device 700 existed in an outside network through the O&M server 530B in a step represented by S1136.

The position estimating device 700 estimates the position by using the position information message and the round trip time of the repeater and the latitude and longitude information of the base station and the repeater, managed as a database through the NMS 520B, and transmits the estimated position to the GMLC 430B in a step represented by S1138.

The GMLC 430B transmits the estimated position to the client in a step represented by S1140.

Although the above description explains that the base station controller 400B generates the position information message, the persons of ordinary skill in the art must understand that the O&M server 530B can generate the position information message.

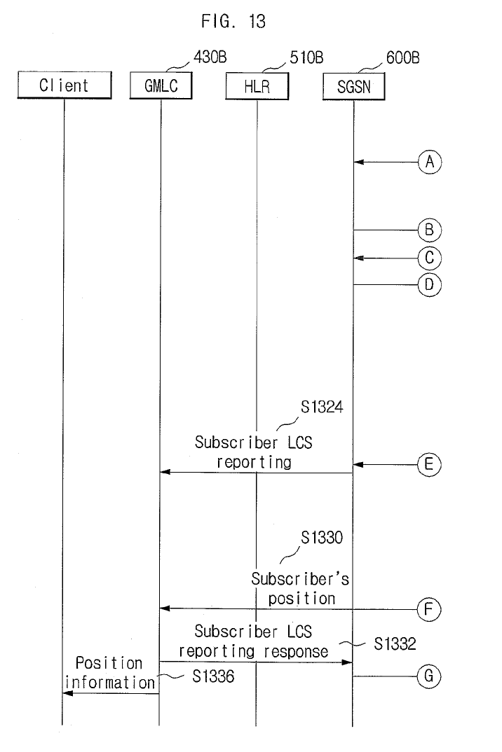

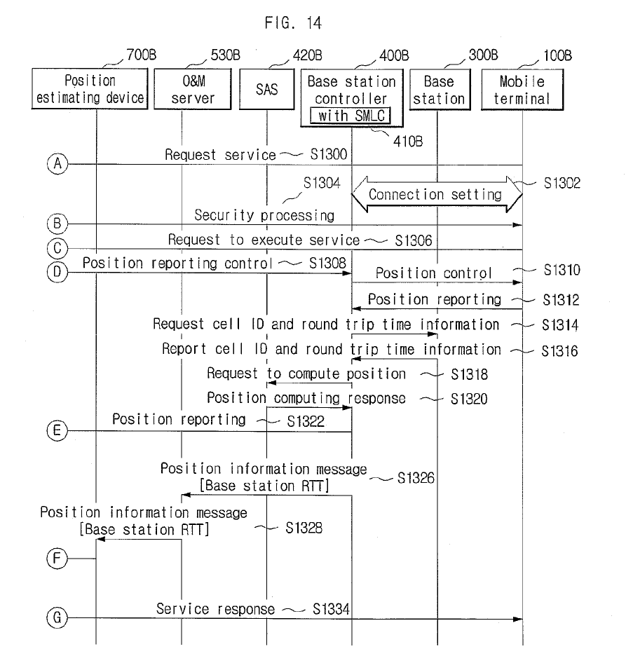

FIG. 13 and FIG. 14 are flow charts illustrating a process for transmitting position information by using a packet call in accordance with a second embodiment of the present invention through a fourth embodiment of the present invention.

When it comes to using a packet call, a process of acquiring routing information is identically performed between the GMLC 430B and the HLR 510B of in FIG. 11 and FIG. 12. However, in the packet call, the position of the mobile terminal is differently requested to the serving GPRS support node 600B instead of the mobile switching center.

After the serving GPRS support node 600B, to which the mobile terminal belongs, is recognized. Then, the mobile terminal 100B requests a service to the serving GPRS support node 600B in a step represented by S1300. Accordingly, the connection between the base station controller 400B and the mobile terminal 100B is set in a step represented by S1302.

Then, the SGSN 600B performs the security processing operation of the mobile terminal 100B in a step represented by S1304. After completing the security processing operation, the mobile terminal 100B transmits a service invoke to the serving GPRS support node 600B in a step represented by S1306, and the serving GPRS support node 600B transmits a location report control message to the base station controller 400B in a step represented by S1308.

Since steps represented by S1310 through S1324 of FIG. 13 and FIG. 4 are identical to those represented by S1118 through S1132 of FIG. 11 and FIG. 12, the pertinent detailed information will be omitted.

In case that the information acquired by the base station controller 400B is the position related information and the round trip time information of the mobile terminal, the base station controller 400B of the present invention generates a position information message by packing the information and transmits the packed information to the O&M server 530B in a step represented by S1326.

Here, the generating of the position information message can be performed in the O&M server 530B.

The position information message passes through the O&M server 530B and is transmitted to the position estimating device 700, provided outside of a network in a step represented by S1328.

The position estimating device 700 estimates the position by using not only the information included in the position information message and the round trip time of the repeater but also the latitude and longitude information of the base station and the repeater, managed as a database through the NMS 520B and transmits the estimated position to the GMLC 430B in a step represented by 1330.

The GMLC 430B transmits a response of the estimated position to the serving GPRS support node 600B in a step represented by S1332 and position information to the client, to which the position is requested in the beginning in a step represented by S1336.

As described above, the base station controller 400B or the O&M server 530B can more exactly compute the position of the mobile terminal due to packing the round trip time information of the mobile terminal and other position information relation information together and transmitting the packed information to the estimating device, provided outside of a network.

In the same system as illustrated in FIG. 5 and FIG. 5 through FIG. 8, the base station 300B is provided at end parts of the system performing the mobile communication network service, and the repeater 200B is used to extend a service radius and remove a shadow area.

There are a lot of areas having the service radius of the base station itself broader than that of the repeater even if the service radius is varied depending on an area and a position. Currently used repeaters include a optical repeater (and/or in-building repeater) and a RF repeater (commonly referred to as the repeater, not wire-connected to the base station and including a digital-band translation repeater, a micro repeater, an ICS repeater and compact-size/micromini indoor repeater), according to a method linking with the base station.

If the mobile terminal is in a direct coverage area through an antenna of the base station, a radius between the base station and the terminal can be relatively exactly estimated through the round trip time.

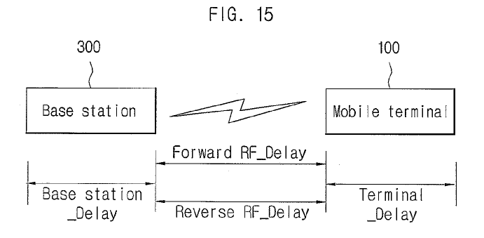

However, in the case of the mobile terminal provided in an area of the optical repeater or the in-building repeater and the RF repeater, the measured value of the round trip time has a relatively large round trip time value due to delay effect such as a self delay component of the optical cable or the repeater. This causes to generate a lot of errors when the radius between the base station and the terminal is measured. The classification of the delay component of the each service area will be described below with reference to FIG. 15 through FIG. 17.

FIG. 15 illustrates a time delay in a service area of a base station.

Referring to FIG. 15, a base station direct service area includes base station self delay (Base station_Delay), wireless link delay to the mobile terminal (Base station_RF_Delay) and mobile terminal self delay (Terminal_Delay). The overall round trip time value is determined by the following Formula 1.

Overall round trip time delay=Base station_Delay+2*base station_RF_Delay [Formula 1]

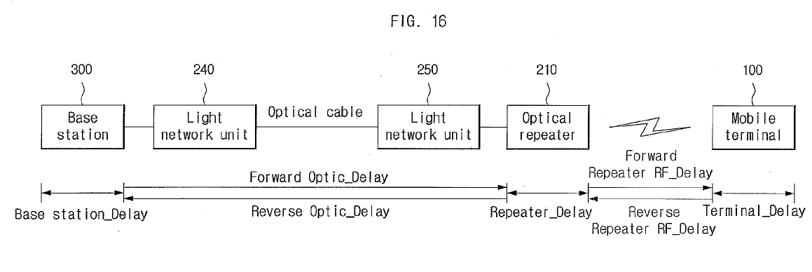

FIG. 16 illustrates a time delay in a service area of a optical repeater. FIG. 16 illustrates the structure of the connection between the base station 300 and the optical repeater 210 by using optical cables and optical termination equipments 240 and 250.

Referring to FIG. 16, the delay of a optical repeater service area includes base station self delay (Base station_Delay), mobile terminal self delay (Terminal_Delay), delay between the base station 300 and the optical repeater through the optical termination equipment 240 and 250 (Optic_delay), optical repeater self delay (Repeater_Delay) and wireless link delay from the optical repeater to the mobile terminal (Repeater_RF_Delay).

At this time, the overall round trip time value is determined by the following Formula 2.

Overall round trip time delay=Base station_Delay+Terminal_Delay+2*Optic_Delay+Repeater_Delay+2*Repeater_RF_Delay [Formula 2]

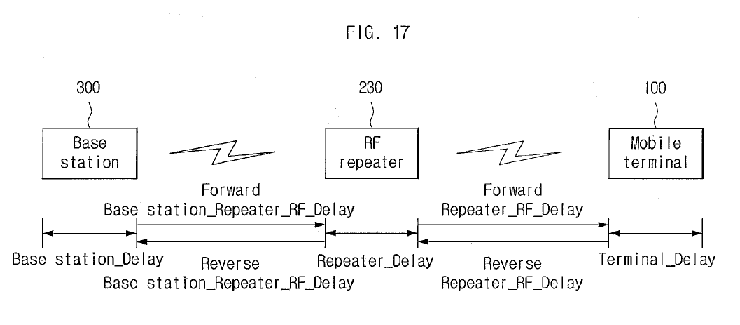

FIG. 17 illustrates a time delay in a service area of an RF repeater.

Referring to FIG. 17, an RF repeater service area includes base station self delay (Base station_Delay), mobile terminal self delay (Terminal_Delay), wireless link delay between a signal source base station (mother base station) and the RF repeater (Base station Repeater_RF_Delay), RF repeater self delay (Repeater delay) and wireless link delay from the RF repeater and the mobile terminal (Repeater_RF_Delay).

At this time, the overall round trip time value is determined by the following Formula 3.

Overall round trip time delay=Base station_Delay+Terminal_Delay+2*Base station_Repeater_RF_Delay+Repeater_Delay+2*Repeater_RF_Delay [Formula 3]

In the above description, the base station self delay, mobile terminal self delay, optical repeater self delay and RF repeater self delay can measure each its delay value. In other words, since each system and terminal has the standard for defining a delay value when producing it, it is no problem to measure the delay value.

One of the biggest problems is the delay component by the optical termination equipment, between the base station and the optical repeater, and the optical cable. Since it is actually difficult that the optical cable between the base station and the optical repeater is installed as a direct path, the installed optical cable is longer than the actual distance between the base station and the optical repeater. If these data is exactly managed as a database, it can be easy to measure the delay value by the help of the database. Actually, the installed distance is not exactly managed as a database. Also, the same goes for the RF repeater.

To exactly estimate a position of the mobile terminal, it is necessary to exactly measure a round trip time value by the repeater in each service area. Accordingly, in accordance with the present invention, the repeater 200 is connected to the round trip time measuring unit 540.

Here, the analyzing unit of the round trip time can be a 1/16 chip. Alternatively, other units are available.

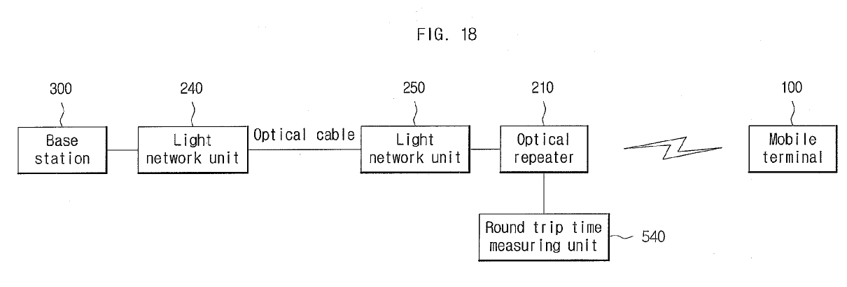

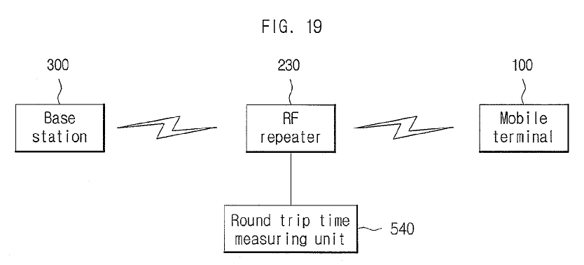

FIG. 18 illustrates a structure of a service area of a optical repeater in accordance with an embodiment of the present invention, and FIG. 19 illustrates a structure of a service area of an RF repeater in accordance with an embodiment of the present invention.

As described above, the element estimating a position by using the round trip time of the mobile terminal and the round trip time of the repeater is referred to as the position estimating device. The element can be the SAS 420, the SMLC 410 and the position estimating device 700 outside of a network.

The round trip time measuring unit 540 of the present invention measures the round trip time values of the optical repeater 210 and the RF repeater 230, to compensate a position estimating error. Preferably, the round trip time measuring unit 540 can be directly wire-connected to a debugger port of the repeater.

By being directly connected to the debugger port, the active set of the round trip time measuring unit 540 can be maintained as one active set, and the delay between the repeater and the round trip time measuring unit 540 can be minimized.

Moreover, the round trip time measuring unit 540 can be the mobile terminal possessed by a user. Unlikely, the round trip time measuring unit 540 can be the terminal previously mounted to transmit information, related to an RF test of the repeater and whether there is an error in the repeater, to the NMS 520.

As described above, since the round trip time measuring unit 540 of the present invention is connected to the repeater in the state that the delay therebetween is minimized, the round trip time value, computed by the round trip time measuring unit 540, becomes a value computed from the Formula 2 and Formula 3 regardless of the wireless link delay from the repeater and the mobile terminal.

Accordingly, the round trip time of the optical repeater and the RF repeater is computed by the following Formula 4 and Formula 5, respectively.

Round trip time of optical repeater=Base station_Delay+Terminal_Delay+2*Optic_Delay+Repeater_Delay [Formula 4]

Round trip time of RF repeater=Base station_Delay+Terminal_Delay+2*Base station_repeater_RF_Delay+Repeater_Delay [Formula 5]

Since the round trip time measuring unit 540 is directly connected to the optical repeater or the RF repeater, the round trip time measured in the round trip time measuring unit 540 can be transmitted to the position estimating device (i.e. one of SAS, SMLC and position estimating device provided outside of a network) by maintaining a traffic state by use of only one active set.

The operation that the round trip time measuring unit 540 transmits the measured round trip time information can be identical to the call processing operation of FIG. 11 and FIG. 11. Also, the operation can be transmitted to the position estimating device 700 in advance and be stored in order to estimate the position of the mobile terminal 100.

In the case of receiving the round trip time information of the mobile terminal 100, the position estimating device compares the received round trip time information with the round trip time of the repeater.

In case that the mobile terminal pertains to a plurality of base station service areas, the round trip time of the mobile terminal can be computed corresponding to at least one base station, and the position estimating device 700 determines whether the round trip time information of the mobile terminal, corresponding to at least one base station, is larger than the round trip time information of the optical repeater or the RF repeater, belonging to each base station.

If the round trip time information of the mobile terminal of a specific base station is larger than the round trip time information of the optical repeater or the RF repeater, belonging to the pertinent base station, the position estimating device 700 determines that the mobile terminal 100 is in the service area of the optical repeater or the RF repeater. In the reverse case, the device 700 determines that the mobile terminal 100 is in the service area of the base station.

After the service area is determined, the device 700 of the present invention estimates an exact position of the mobile terminal by referring to latitude and longitude information of the base station and the repeater, stored in the NMS 520.

For example, in case it is determined that the mobile terminal 100 is in the service area of a specific repeater, the position estimating device computes the distance located with the mobile terminal in the pertinent repeater through the following Formula 6.

Distance from the repeater=(Round trip time of the mobile terminal−Round trip time of the repeater)/2*3*500 [Formula 6]

In the meantime, in case that the mobile terminal 100 is in the service area of the base station, the distance located with the mobile terminal in the base station is computed through Formula 7.

Distance from the repeater=(Round trip time of the mobile terminal−Round trip time of the repeater)/2*3*500 [Formula 7]

In accordance with the present invention, the position estimating device can receive a round trip time value of the mobile terminal corresponding to at least base station. In this case, the position estimating device can estimate the position of a pertinent mobile terminal 100 by computing the distance of the mobile terminal 100 in each base station (or the repeater belonging to the base station).

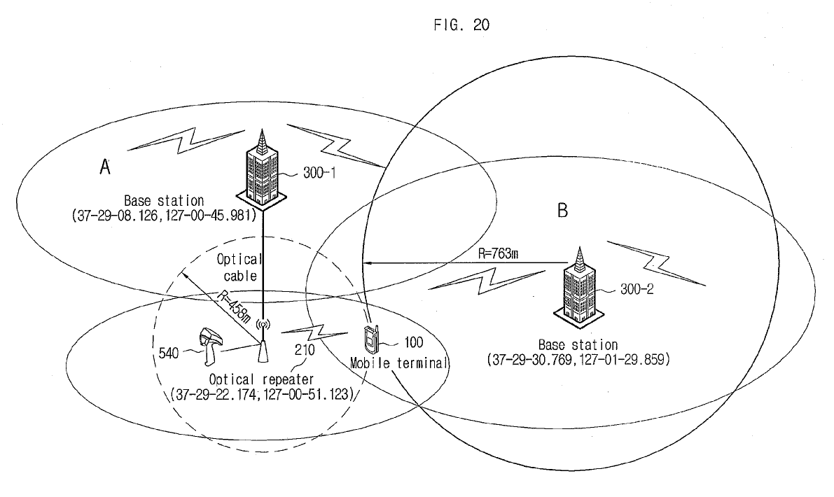

FIG. 20 illustrates an example illustrating a position estimating method by using a round trip time in accordance with the present invention. FIG. 20 is an example illustrating the process that the position estimating device, provided outside of a network, receives a position information message and estimates a position of the mobile terminal.

In FIG. 20, below is listed the basic assumptions.

1) Latitude/longitude of base station A 300-1: 37-29-08.126, 127-00-45.981

2) Latitude/longitude of base station B 300-2: 37-29-30.769, 127-01-29.859

3) Latitude/longitude of optical repeater: 37-29-22.174, 127-00-51.123

4) Round trip time analysis unit: 1/16 chip

5) Base station self delay (Base station_Delay): 640

6) Round trip time of optical repeater: 1200

Also, below is shown the information included in the position information message received from the O&M server 530 in accordance with the present invention.

TABLE 8
Position information message for an example of FIG. 18

| | Round trip time | Mobile | |
|---|---|---|---|
| Information | measuring unit | terminal | Remark |
| Msg ID | 1 | 1 | |
| Seq ID | 1 | 2 | |
| Time | 00:00:00:00 | 00:00:20:00 | |
| Mobile ID | 010-####-#### | 010-####-#### | |
| REF_PN | 4 | 4 | |
| Number of PN | 1 | 2 | |
| MSC[0] | 1 | 1 | |
| BSC[0] | 1 | 1 | |
| Base station [0] | 1 | 1 | |
| SEC[0] | 0 | 0 | |
| PN[0] | 4 | 8 | |
| (pseudo noise) | | | |
| PN_PHASE[0] | 0 | 0 | In units of 1 chip |
| PN_Strength[0] | 4 | 8 | |
| Round trip | 520 | 550 | In units of 1/16 chip |
| time [0] | | | |
| NID[1] | | 1 | |
| BSC[1] | | 1 | |
| Base station [1] | | 2 | |
| SEC[1] | | 0 | |
| PN[1] | | 8 | |
| PN_PHASE[1] | | 497 | In units of 1 chip |
| PN_Strength[0] | | 14 | |
| RTD[1] | | 290 | In units of 1/16 chip |

Table 8 simultaneously shows position information messages transmitted from the round trip time measuring unit 540 and the mobile terminal 100. RTD[0] is a round trip time value of the mobile terminal corresponding to a base station A. RTD[1] is a round trip time value of the mobile terminal corresponding to a base station B.

In FIG. 20, the mobile terminal 100 consists of 2 active sets.

In the meantime, the round trip time measuring unit 540, which is in a state of being connected by one active set, computes the round trip time by Formula 4.

Referring to FIG. 20 and Table 8, the round trip time of the mobile terminal corresponding to a base station A 300-1 is 2380, and the round trip time of the mobile terminal corresponding to a base station B 300-2 is 940.

For the base station A, since 2380, the round trip time of the mobile terminal is larger than 2200, the round trip time of the optical repeater connected to the base station A, it is determined that the mobile terminal 100 is located in a service area of the optical repeater.

Meanwhile, for the station B, since the round trip time of the mobile terminal is 940 and there is no round trip time of the repeater, it is determined that the mobile terminal 100 is located in a service area of the base station B.

Accordingly, the radiuses based on the repeater of the base station A and the base station B, which can be computed through the round trip time, is computed through the Formulas 6 and 7 as follows.

Radius based on the optical repeater connected to the base station B=(2380−2200)/2/16*3*500/3,840,000=440(m)

Radius based on the base station B=(940−640)/2/16*3*500/3,840,000=732(m)

Here, 1/16 is an analyzing unit, which can be realized by varying the resolving power per receiving chip manufacturing company.

In the case of computing the radius based on the repeater and the base station by the aforementioned method, as illustrated in FIG. 20, the position of the mobile terminal 100 can be exactly estimated.

In the case of estimating the position of the mobile terminal without using the round trip time unlike the present invention, a big error is generated.

For example, the radius based on the round trip time of the base station A is computed, a big error is generated as follows.

Radius based on the base station A=(2380−2200)/2/16*3*500/3,840,000=4730

At least one embodiment of the present invention can recognize a service area of the mobile terminal to exactly estimate the position. Beside that, since in the case of one base station includes a lot of repeaters, the present invention can check which repeater's service area the mobile terminal is located in. This causes to be able to estimate an exact position.

In the meanwhile, when providing a service in a building by using an in-building repeater, since the repeater has a strong receiving signal of the mobile terminal in case that the mobile terminal is in a traffic state, there are a lot of possibilities of checking that one active set is provided through a position information message. In this case, it can be sufficient to recognize that a subscriber is located inside of the building through the round trip time of the repeater, particularly.

As described above, at least one embodiment of the present invention can estimate an exact position of a mobile terminal by linking with a network management system storing latitude/longitude of a base station and a repeater and antenna direction information. Also, at least one embodiment of the present invention can estimate an exact position of a mobile terminal by using round trip time information of a repeater.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A system for estimating a position of a mobile terminal, the system comprising:
a base station configured to compute first round trip time information of a mobile terminal;
a base station controller configured to receive the first round trip time information;
a repeater configured to expand a service coverage of the mobile terminal;
a round trip time measuring unit being in signal communication with the repeater and configured to measure second round trip time information of the repeater; and
a position estimating device configured to estimate the position of the mobile terminal based at least in part on the first and second round trip time information.

2. The system of claim 1, further comprising a network managing system configured to store at least one of latitude and longitude data of the base station and repeater and direction information of an antenna,
wherein the position estimating device is further configured to estimate the position of the mobile terminal based at least in part on the data stored in the network managing system.

3. The system of claim 1, wherein the repeater is an optical repeater or an RF repeater, and the round trip time measuring unit is further configured to compute the second round trip time information based at least in part on at least one of i) self delay of the base station, ii) self delay of the mobile terminal, iii) wireless link delay between the base station and the repeater, and iv) self delay of the repeater.

4. The system of claim 1, wherein the position estimating device is further configured to determine a service area of the mobile terminal based at least in part on comparison of the first round trip time information, corresponding to at least one base station, and the second round trip time information corresponding to at least one repeater belonging to each base station.

5. The system of claim 1, wherein the position estimating device is at least one of a standalone A-GPS serving mobile location center (SMLC), being connected to the base station controller, an SMLC, being included in the base station controller, and an apparatus for estimating a position, located outside a network.

6. The system of claim 5, further comprising an operating and management (O&M) server, configured to maintain and repair the base station,
wherein, if the position estimating device is an apparatus for estimating a position, located outside the network, at least one of the base station controller and the O&M server is configured to generate a position information message by packing position related information and the first round trip time information.

7. The system of claim 6, wherein the position related information comprises at least one of i) an identifier of a mobile switching center for a circuit call included in a mobile communication network, ii) an identifier of a base station controller, iii) an identifier of a base station, iv) an identifier of a sector, v) pseudo noise information, and vi) primary scrambling code information.

8. The system of claim 6, wherein the position information message is configured to be transmitted via a circuit call or a packet call.

9. A system for estimating a position of a mobile terminal, the system comprising:
a base station configured to compute round trip time information of the mobile terminal;
a base station controller configured to generate a position information message by packing the round trip time information and position related information of the mobile terminal; and
a position estimating device configured to estimate a position of the mobile terminal based at least in part on the position information message.

10. The system of claim 9, further comprising an operating and management (O&M) server, configured to maintain and repair the base station,
wherein the O&M server is further configured to relay the position information message between the base station controller and the position estimating device.

11. The system of claim 9, wherein the position related information comprises at least one of i) an identifier of a mobile switching center for a circuit call included in a mobile communication network, ii) an identifier of a base station controller, iii) an identifier of a base station, an identifier of a sector, iv) pseudo noise information, and v) primary scrambling code information.

12. The system of claim 9, wherein the position information message is configured to be transmitted via a circuit call or a packet call.

13. A method of estimating a position of a mobile terminal in a position estimating device of a mobile communication system, the method comprising:
receiving first round trip time information of the mobile terminal;
receiving second round trip time information of a repeater;
determining a service area of the mobile terminal based at least in part on comparison of the first and second round trip time information; and
estimating a position of the mobile terminal based at least in part on at least one of latitude/longitude data of the repeater and the base station, connected to the repeater, and direction information of an antenna, based on the determined service area.

14. The method of claim 13, wherein the receiving of the first round trip time information comprises:
receiving the first round trip time information computed in a repeater;
generating a position information message by packing the first round trip time information with the position related information of the mobile terminal; and
receiving the position information message from a base station controller or a packing message repeater.

15. The method of claim 14, wherein the packing message repeater is an operating and management (O&M) server, configured to maintain and repair the base station.

16. The method of claim 14, wherein the position related information comprises at least one of i) an identifier of a mobile switching center for a circuit call included in a mobile communication network, ii) an identifier of a base station controller, iii) an identifier of a base station, iv) an identifier of a sector, v) pseudo noise information, and vi) primary scrambling code information.

17. The method of claim 13, wherein the repeater is an optical repeater or an RF repeater, and wherein the second round trip time information is measured based at least in part on at least one of i) self delay of the base station, ii) self delay of the mobile terminal, iii) wireless link delay between the base station and the repeater, and iv) self delay of the optical repeater.

18. The method of claim 13, wherein the determining is performed by comparing the first round trip time information corresponding to at least one base station, with the second round trip time information corresponding to at least one repeater belonging to each base station.

19. A method of estimating a position of a mobile terminal in a mobile communication system, the method comprising:
computing, at a base station, round trip time information of the mobile terminal;
receiving, at a base station controller being in data communication with the base station, the round trip time information and position related information of the mobile terminal;
generating, in at least one of the base station controller and an operating and management (O&M) server, a position information message by packing the round trip time information and the position related information of the mobile terminal; and
estimating a position of the mobile terminal based at least in part on the position information message position of the mobile terminal.

20. The method of claim 19, wherein the position related information comprises at least one of i) an identifier of a mobile switching center for a circuit call included in a mobile communication network, ii) an identifier of a base station controller, iii) an identifier of a base station, iv) an identifier of a sector, v) pseudo noise information, and vi) primary scrambling code information.
